(19) United States
(12) Patent Application Publication
(10) Pub. No.: US 2016/0058531 A1
(43) Pub. Date: Mar. 3, 2016

(54) TOOTH-CLEANING DEVICE

(71) Applicant: SPADA FORNITURE DI SPADA GIUSEPPE, San Maurizio Canavese (TO) (IT)

(72) Inventors: Davide Adriano, San Maurizio Canavese (IT); Gabriele Adriano, San Maurizio Canavese (IT)

(21) Appl. No.: 14/783,550

(22) PCT Filed: Mar. 26, 2014
(86) PCT No.: PCT/IT2014/000079

§ 371 Date: Oct. 9, 2015

(30) Foreign Application Priority Data
Apr. 11, 2013 (IT) TO2013U000060

(51) Int. Cl. A61C 15/02; A46B 3/00

(52) U.S. Cl. CPC A61C 15/02; A46B 3/005; A46B 2200/108

(57) ABSTRACT

A tooth-cleaning device (1) is described, comprising at least one supporting body (3) and at least one tooth-cleaning appendix (5), such tooth-cleaning appendix (5) being made of a first material and such supporting body (3) being made of a second material, such first material being more flexible than such second material, such first material being at least one thermosetting plastic material.

The present invention refers to a tooth-cleaning device.

The art proposes tooth cleaning devices, typically called interdental brushes, aimed in particular to clean interdental spaces, remove food residuals, reactivate blood micro-circulation or clean fixed prostheses. The art proposes a great number of variations of such devices: in general, they are usually composed of a body made of plastics or of metal adapted to be grasped by the fingers of a user, and of a cleaning appendix equipped with artificial bristles arranged as a spiral or rays having a cylindrical or cylindrical-conical shape.

In particular, EP-A1-0932371 discloses an interdental cleaning device comprising a supporting rod made of a first plastic material and coated along at least part of its surface with an insert or coating making the appendix for cleaning spaces between teeth, and made of a second plastic material in thermoplastic elastomer which is more flexible than the first one, in which however such second material is injection molded onto such first material: it must be noted therefore how, in particular, such interdental cleaning device is made through an injection co-molding of the supporting rod with the insert or coating for cleaning spaces between teeth, only obtaining a physical grasping between supporting rod and insert or coating.

Moreover, the thermoplastic material to obtain the cleaning appendix can have the problem of possible tears: consequently, when a cleaning appendix made of such material is used in very narrow spaces between teeth, it can leave plastic residuals inside the mouth.

Object of the present invention is solving the above prior art problems, by providing a tooth-cleaning device in which the cleaning appendix is made of at least one thermosetting plastic material, resulting more biocompatible with respect to prior art devices with cleaning appendixes made of thermoplastic materials.

Another object of the present invention is providing a tooth-cleaning device in which the cleaning appendix is made of at least one thermosetting plastic material, resulting more pleasant with respect to prior art devices with cleaning appendixes made of thermoplastic material s, consequently removing the risk of tears when it is used in very narrow spaces between teeth, together with the problem of releasing residuals in a mouth.

Moreover, another object of the present invention is providing a tooth-cleaning device in which the cleaning appendix is made of at least one thermosetting plastic material, resulting free from possible bacterial aggressions.

Another object of the present invention is providing a tooth-cleaning device in which the cleaning appendix made of at least one thermosetting plastic material over-molded on a supporting body made of a thermosetting plastic material, in such a way as to obtain a fastening between cleaning appendix and supporting body which is both of the chemical type due to reticulation, and of the physical type due to over-molding.

The above and other objects and advantages of the invention, as will result from the following description, are obtained with a tooth-cleaning device as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

The present invention will be better described by some preferred embodiments thereof, provided as a non-limiting example, with reference to the enclosed drawings, in which:

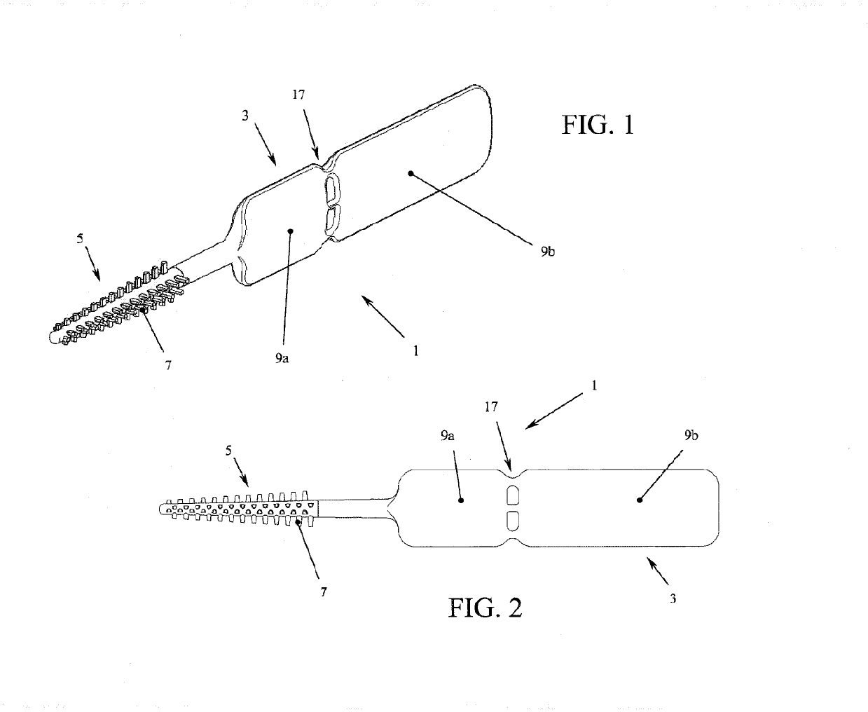

FIG. 1 shows a perspective view of a preferred embodiment of the tooth-cleaning device according to the present invention;

FIG. 2 shows a side view of the tooth-cleaning device of FIG. 1;

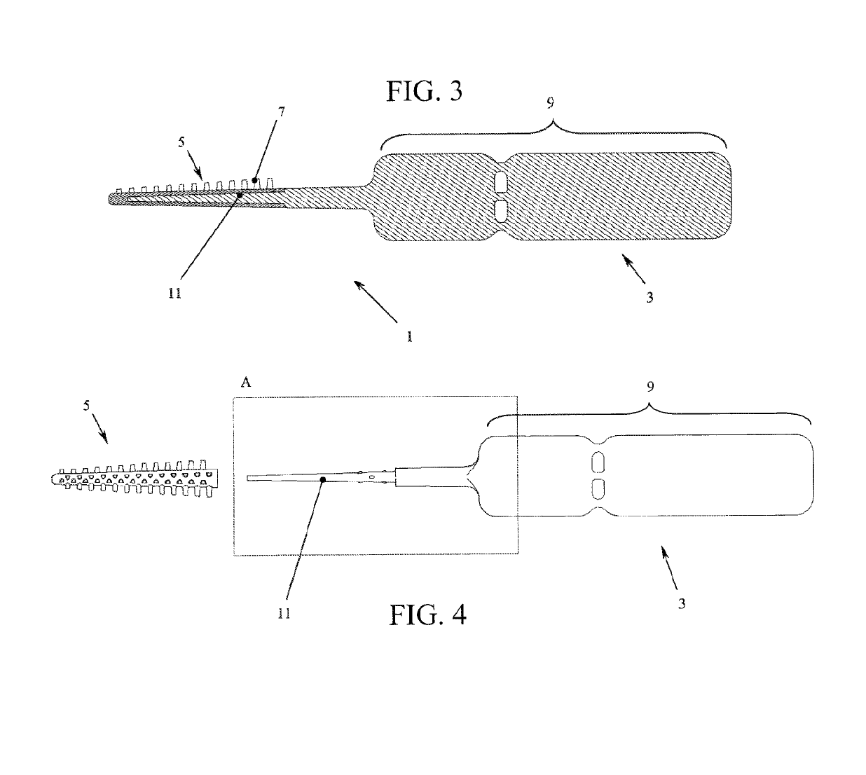

FIG. 3 shows a longitudinally sectioned view of the tooth-cleaning device of FIG. 1;

FIG. 4 shows an exploded view of the tooth-cleaning device of FIG. 1;

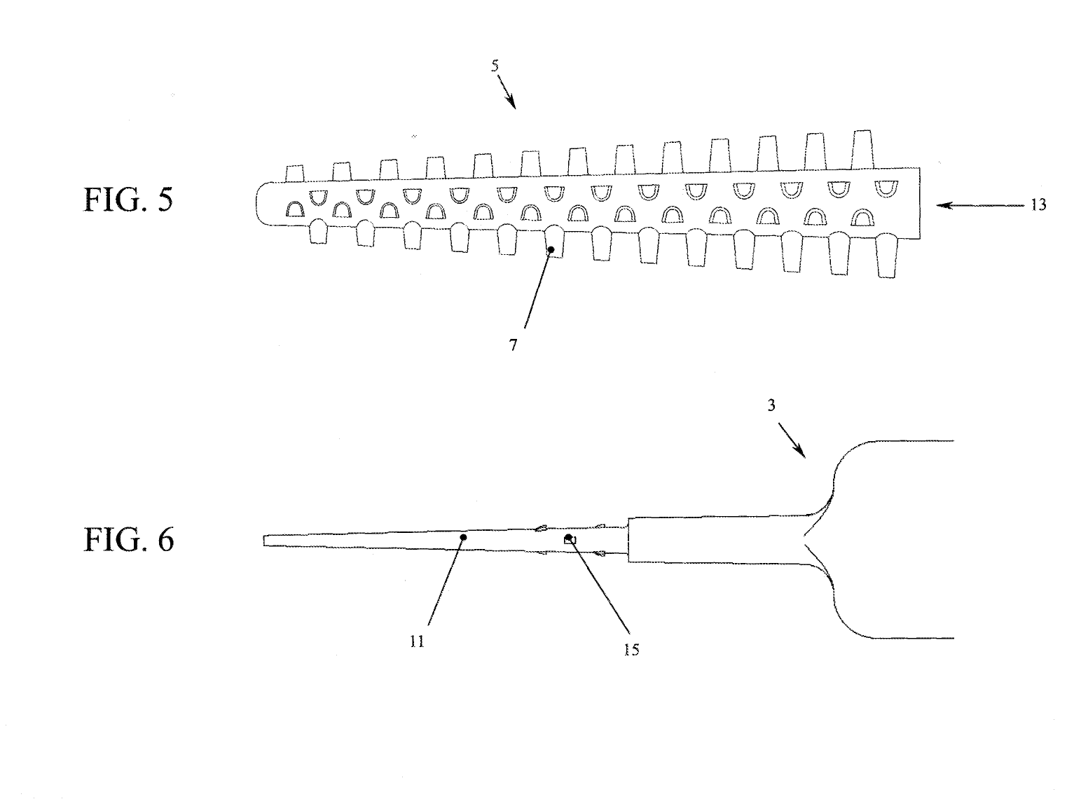

FIG. 5 shows an enlarged view of a preferred embodiment of a component of the tooth-cleaning device of FIG. 1;

FIG. 6 shows an enlarged view of the detail of box A in FIG. 4;

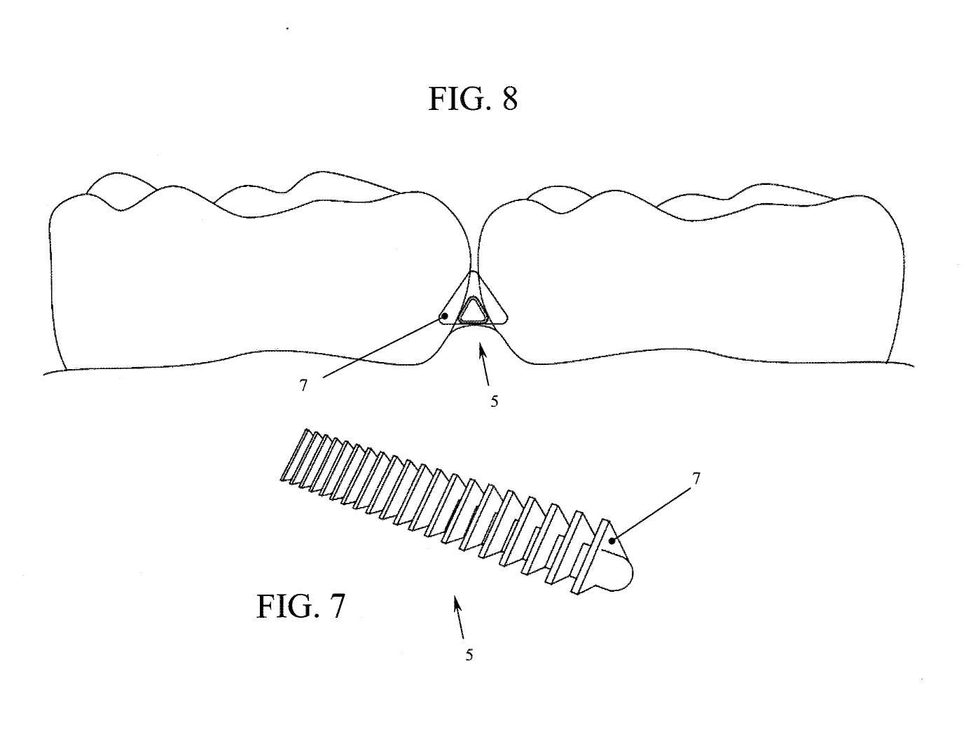

FIG. 7 shows a perspective view of a variation of an embodiment of a component of the tooth-cleaning device according to the present invention;

FIG. 8 shows a use mode of the component of FIG. 7;

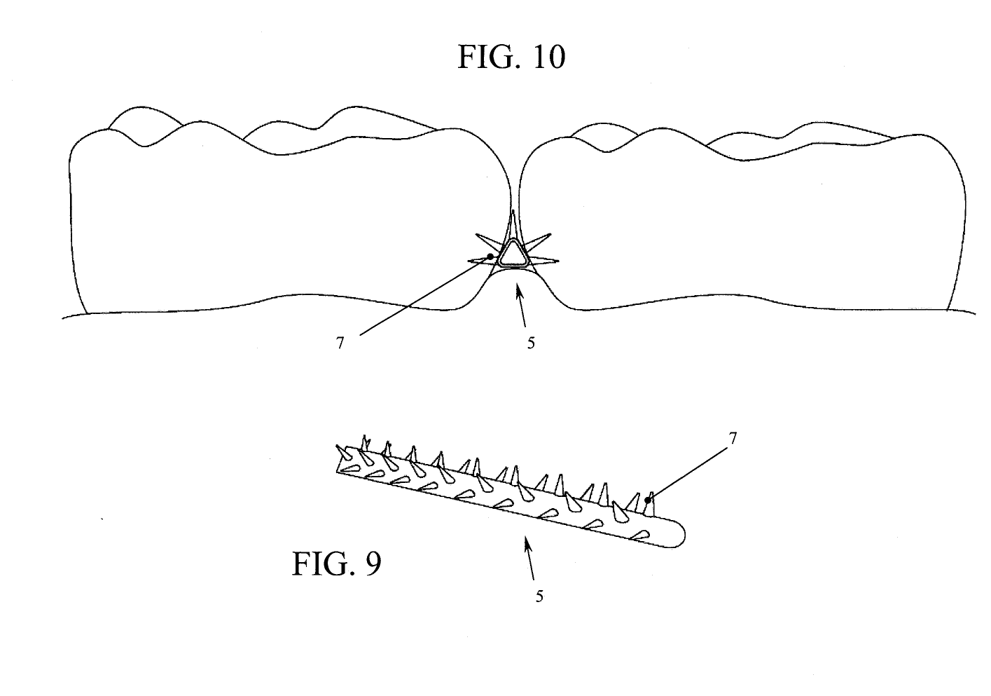

FIG. 9 shows a perspective view of another variation of an embodiment of a component of the tooth-cleaning device according to the present invention;

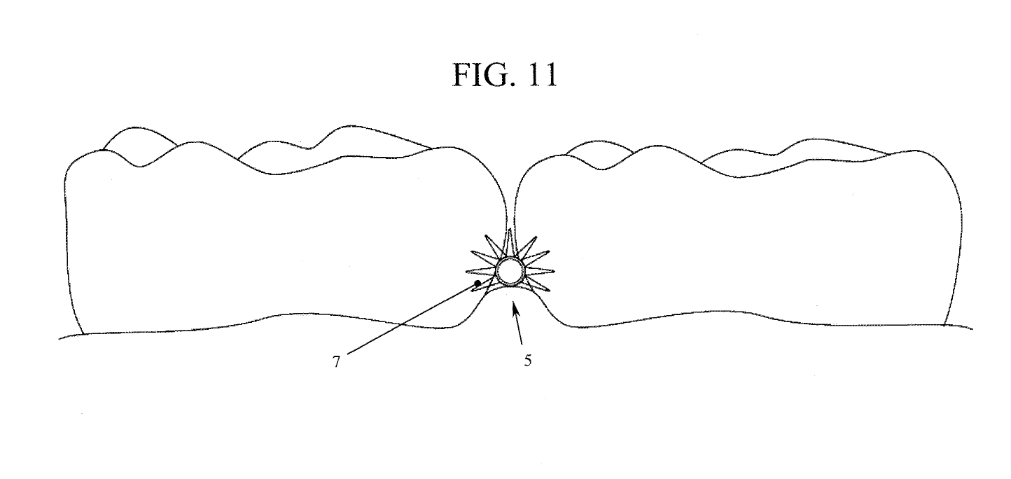

FIG. 10 shows a use mode of the component of FIG. 9; and

FIG. 11 shows a use mode of a further variation of the component of the tooth-cleaning device according to the present invention.

With reference to the Figures, it is possible to note that the tooth-cleaning device 1 according to the present invention comprises at least one supporting body 3 and at least one tooth-cleaning appendix 5, preferably such tooth-cleaning appendix 5 being externally equipped with one or more cleaning bristles 7.

In general, such tooth-cleaning appendix 5 is made of a first material and such supporting body 3 is made of a second material, such first material being more flexible than such second material.

Advantageously, such first material of which such tooth-cleaning appendix 5 is made, is at least one thermosetting plastic material, such thermosetting plastic material being preferably a Liquid Silicone Rubber, LSR.

In addition, such first material can be charged with suitable nanocharges which strongly increase the abrasion resistance of the tooth-cleaning appendix 5, and in particular of the bristles 9, highly increasing the detergent effect on the tooth enamel of the device 1 according to the present invention. Obviously, such nanocharges suitable for this purpose can be various and have, for example, inorganic origin (such as clays, titanium dioxide or glass) or organic origin (such as nanocellulose).

Preferably, such second material of which such supporting body 3 is made, is at least one plastic material, for example at least one thermoplastic plastic material. Still more preferably, such second material of which such supporting body 3 is made, is at least one thermosetting plastic material.

In particular, the tooth-cleaning appendix 5 is adapted to be connected to the supporting body 3: preferably, such supporting body 3 is composed of at least one catching portion 9 by the fingers of a user, and of at least one connecting portion 11 to such tooth-cleaning appendix 5. In a first preferred embodiment of the device 1 according to the present invention, like the one for example shown in particular in FIG. 3, such tooth-cleaning appendix 5 made of thermosetting plastic material is connected to such supporting body 3 through over-molding on the supporting body 3 itself, and in particular on such connecting portion 11.

Preferably, it is possible to provide that also the plastic material of which such supporting body 3 is made, or at least such connecting portion 11, is charged with fibres and/or with nanocharges: such fibres and/or nanocharges can be mainly suitable for increasing the mechanical resistance and/or the stiffness of such supporting body 3; moreover, above all when the plastic material of which such supporting body 3 is made is a thermoplastic material, such fibres can be adapted to increase the molding temperature of such material to get it nearer to the temperature of the first thermosetting material of which the tooth-cleaning appendix 5 is made.

Obviously, also such fibres suitable for this purpose can be various and be, for example, glass fibres or have natural origin (such as flax or hemp).

It must further be noted how, advantageously, if also the supporting body 3, and in particular at least the connecting portion 11, is made of a thermosetting plastic material, the over-molding of the tooth-cleaning appendix 5 made of thermosetting material on such supporting body 3, or at least on such connecting portion 11, generates between the cleaning appendix 5 and the supporting body 3, and in particular at least the connecting portion 11, in addition to a fastening of a physical type due to the over-molding process, the making of covalent links between such materials, the consequent reticulation and the making also of a strong connection due to fastening of the chemical type.

Alternatively, as it is possible to note in particular in FIG. 4, the supporting body 3 and the tooth-cleaning appendix 5 can be made separately and afterwards mutually constrained one to the other to assemble the device 1 according to the present invention: in such case, such connecting portion 11 is adapted to be inserted inside a suitable longitudinal recess 13 of such tooth-cleaning appendix 5 to make the connection between the tooth-cleaning appendix 5 and the supporting body 3. Obviously, it is possible to provide any type of connection between such supporting body 3 and such tooth-cleaning appendix 5 suitable for this purpose, without thereby departing from the scope of the present invention. In particular, the strengthening of the connection between such supporting body 3 and such tooth-cleaning appendix 5 can be made, for example, by:
interposing at least one layer of gluing agent; and/or
fastening due to mechanical interference, friction, plastic/elastic distortion, etc.; and/or
mechanically connecting: in this case, to strengthen the connection between such tooth-cleaning appendix 5 and such supporting body 3, mechanical retention means are interposed between such connecting portion 11 and such recess 13, such mechanical retention means preferably comprising at least one fastening tooth 15 arranged along such connecting portion 11 and adapted to engage at least one respective engagement seat arranged along such recess 13.

In a possible embodiment of the tooth-cleaning appendix 5 as shown in FIGS. 7 and 8, each bristle 7 has a triangular shape, a plurality of such bristles 7 being arranged aligned along the longitudinal axis of the tooth-cleaning appendix 5 itself.

In an alternative embodiment of the tooth-cleaning appendix 5 like the one shown in FIGS. 9, 10 and 11, each bristle 7 has a pointed shape, a plurality of such bristles 7 being radially arranged around the tooth-cleaning appendix 5.

In a further alternative, not shown, each bristle is composed of a circular crown, a plurality of such circular crowns being arranged axially aligned along such tooth-cleaning appendix 5.

In any case, it is also possible to provide that at least the tooth-cleaning appendix 5 is subjected to a spray flocculating treatment.

1-18. (canceled)

19. A tooth-cleaning device comprising at least one supporting body and at least one tooth-cleaning appendix, the tooth-cleaning appendix being made of a first material and the supporting body being made of a second material, the first material being more flexible than the second material, the first material being at least one thermosetting plastic material, wherein the tooth-cleaning appendix made of thermosetting material is over-moulded on the supporting body.

20. The tooth-cleaning device of claim 19, wherein the thermosetting plastic material is a silicone rubber.

21. The tooth-cleaning device of claim 19, wherein the thermosetting plastic material is charged with nanocharges.

22. The tooth-cleaning device of claim 19, wherein the second material is at least one thermoplastic plastic material.

23. The tooth-cleaning device of claim 22, wherein the second plastic material is charged with fibres and/or nanocharges.

24. The tooth-cleaning device of claim 19, wherein the second material is at least one thermosetting plastic material.

25. The tooth-cleaning device of claim 24, wherein the second plastic material is charged with fibres and/or nanocharges.

26. The tooth-cleaning device of claim 19, wherein the supporting body is composed of at least one catching portion and of at least one connecting portion to the tooth-cleaning appendix.

27. The tooth-cleaning device of claim 26, wherein the tooth-cleaning appendix made of thermosetting material is over-moulded on the connecting portion.

28. The tooth-cleaning device of claim 26, wherein the connecting portion is adapted to be inserted inside a longitudinal recess of the tooth-cleaning appendix to make a connection between the tooth-cleaning appendix and the supporting body.

29. The tooth-cleaning device of claim 28, wherein mechanical retention means are interposed between the connecting portion and the recess.

30. The tooth-cleaning device of claim 29, wherein the mechanical retention means comprise at least one fastening tooth arranged along the connecting portion and adapted to engage at least one respective engagement seat arranged along the recess.

31. The tooth-cleaning device of claim 19, wherein the tooth-cleaning appendix is externally equipped with one or more cleaning bristles.

32. The tooth-cleaning device of claim 31, wherein each of the bristles has a triangular shape, a plurality of the bristles being arranged aligned along a longitudinal axis of the tooth-cleaning appendix.

33. The tooth-cleaning device of claim 31, wherein each of the bristles has a pointed shape, a plurality of the bristles being radially arranged around the tooth-cleaning appendix.

34. The tooth-cleaning device of claim 31, wherein each of the bristles is composed of a circular crown, a plurality of the circular crowns being arranged axially aligned along the tooth-cleaning appendix.

35. The tooth-cleaning device of claim 19, wherein at least the tooth-cleaning appendix is subjected to a spray flocculating treatment.
